(19) United States
(12) Patent Application Publication
(10) Pub. No.: US 2016/0224077 A1
(43) Pub. Date: Aug. 4, 2016

(54) ENCLOSURE OF ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XIAO-LI ZHANG, Wuhan (CN); LIN YU, Wuhan (CN)

(21) Appl. No.: 14/695,561

(22) Filed: Apr. 24, 2015

(30) Foreign Application Priority Data
Jan. 31, 2015 (CN) 201510049400.6

(51) Int. Cl. G06F 1/20; G06F 1/18

(52) U.S. Cl. CPC G06F 1/20; G06F 1/188

(57) ABSTRACT

An enclosure includes a chassis received a plurality of heating elements and a power supply unit. The chassis defines a plurality of air inlets. The power supply unit includes a fixing bracket and a power supply fan fixed in the fixing bracket. The fixing bracket defines a plurality of air vents and a plurality of air outlets. The airflow can enter into the enclosure through the air inlets and enter into the fixing bracket through the air vents after taking away the heat of the heating elements. The airflow will dissipate out of the enclosure from the air outlets under the drive of power supply fan.

### CROSS-REFERENCE TO RELATED APPLICATIONS

This application claims priority to Chinese Patent Application No. 201510049400.6 filed on Jan. 31, 2015, the contents of which are incorporated by reference herein.

### FIELD

The subject matter herein generally relates to electronic devices, and more particularly to an enclosure of an electronic device.

### BACKGROUND

With the development of science and technology, the computer is widely used. Electronic components in the computer generate more heat which needs to be dissipated by a plurality of heat sinks. However, for some small computers, an interior of a case of the computer is small.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of an enclosure of an electronic device.

FIG. 2 is an isometric, assembled view of an enclosure of FIG. 1.

FIG. 3 is similar to FIG. 2, but viewed from a different aspect.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising” when utilized, means “including, but not necessarily limited to”; it specifically indicates open-ended inclusion or membership in the so-described combination, group, series and the like.

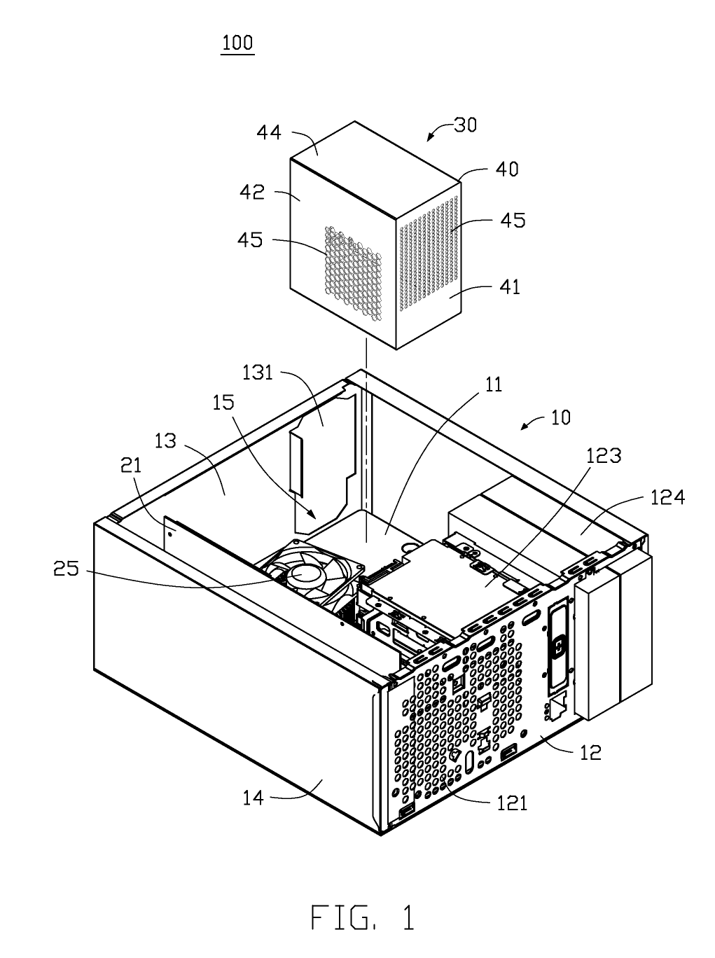

FIG. 1 illustrates one embodiment of an enclosure 100 of an electronic device. The enclosure 100 includes a chassis 10, a power supply unit 30 which is received in the chassis 10 and a cover plate (not shown).

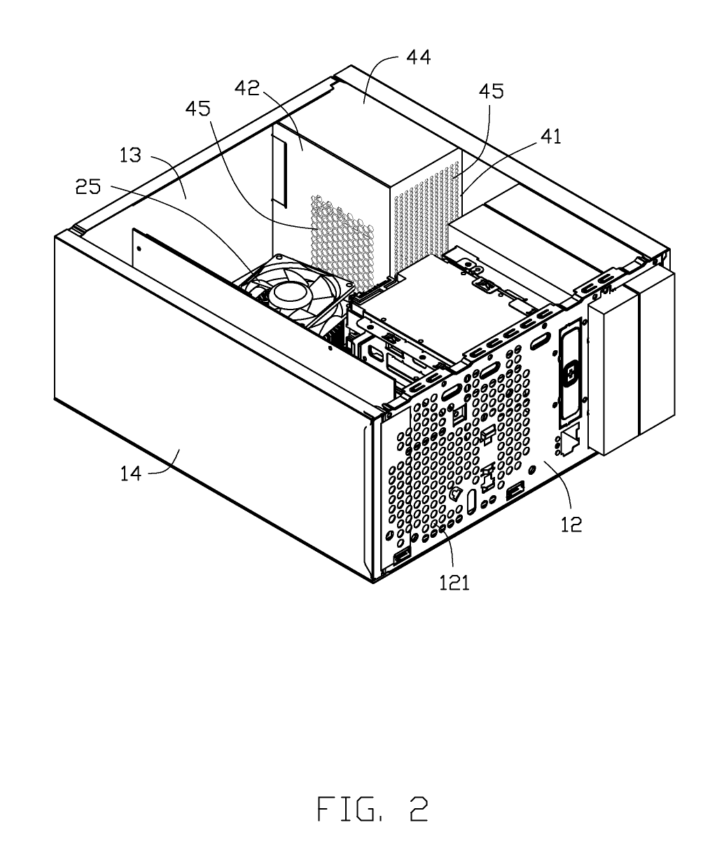

FIGS. 1 and 2 illustrate that the chassis 10 includes a bottom plate 11, a front plate 12, a rear plate 13, and two side plates 14. The bottom plate 11, the front plate 12, the rear plate 13, and the two side plates 14 cooperatively define a receiving space 15. A board (not shown in FIGS.) is located on the bottom plate 11. The board is equipped with a first heating element 21 and a second heating element (not shown in FIGS). A cooling fan 25 is located on the second heating element. In one embodiment, the first heating element 21 is a graphics card and the second heating element is a CPU.

The front plate 12 is connected with one end of the bottom plate 11 and is substantially perpendicular to the bottom plate 11. The front plate 12 defines a plurality of air inlets 121. The airflow can pass through the air inlets 121 to enter into the receiving space 15. The front plate 12 is equipped with a plurality of third heating elements 123 and a plurality of fourth heating elements 124. The airflow can take away the heat of the third heating elements 123 and the fourth heating elements 124. In one embodiment, the third heating elements 123 are hard disks and the fourth heating elements 124 are CD-ROMs.

The rear plate 13 is connected with another end of the bottom plate 11 and is substantially perpendicular to the bottom plate 11. One end of the rear plate 11 defines an opening 131. Two side plates 14 are fixed on two sides of the bottom plate 11 and are substantially perpendicular to the bottom plate 11, the front plate 12 and the rear plate 13.

FIGS. 1 to 3 illustrate that the power supply unit 30 includes a power supply (not shown in FIGS.), a fixing bracket 40, and a power supply fan 50 received in the fixing bracket 40. The fixing bracket 40 includes a first plate 41, a second plate 42, a third plate 43, a fourth plate (not shown in FIGS.), and two parallel fixing plates 44. The first plate 41 and the second plate 42 are perpendicular to each other. The first plate 41 and the second plate 42 define a plurality of air vents 45. The third plate 43 is supported on the rear plate 13. The third plate 43 is substantially perpendicular to the second plate 42 and is substantially parallel to the first plate 41. The third plate 43 defines a plurality of air outlets 431 and an interface 435. The airflow can pass through the air outlets 431 to go out of the enclosure 100. The interface 435 is used to connect the external power supply. The fourth plate is rested on one of the side plate 14. One of the fixing plates 44 is fixed on the bottom plate 11 to fix the fixing bracket 40 on the chassis 10. The power supply fan 50 is fixed on the third plate 43 and is aligned with the air outlets 431.

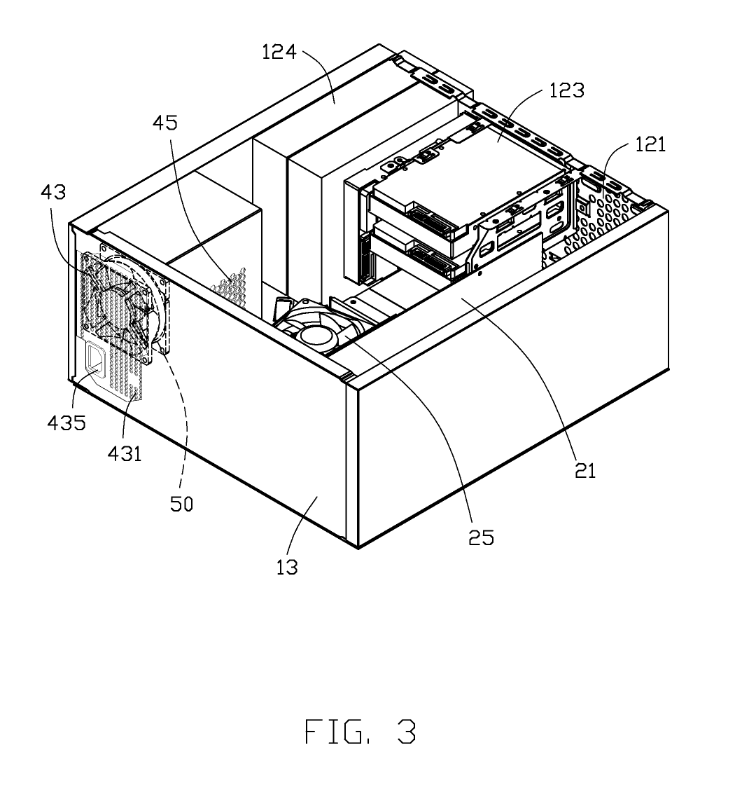

FIGS. 2 and 3 illustrate when in assembly, the power supply and the power supply fan 50 are located in the fixing bracket 40. The power supply fan 50 is fixed on the third plate 43 and is aligned with the air outlets 431. Then, the power supply unit 30 is completely assembled. The power supply unit 30 is placed in the receiving space 15. One of the fixing plates 44 is fixed on the bottom plate 11. The third plate 43 is fixed on the rear plate 13 and the air outlets 431 are aligned with the opening 131. The fourth plate is fixed on the side plate 14. Thus, the power supply unit 30 is fixed in the chassis 10. The cover plate is fixed on the chassis 10 and the enclosure 100 is completely assembled.

When the interface 435 is connected with the external power supply, the heating element within the enclosure 100, the cooling fan 25, and the power supply fan 50 are all working. The cold airflow passes through the air inlets 121 and enters into the receiving space 15. The airflow will enter into the cooling fan 25 after taking away the heat of the first heating element 21, the second heating element, the third heating element 123 and the fourth heating element 124. Then, the airflow passes through the first plate 41 and the air vents 45 of the second plate to enter into the power supply unit 30. The airflow goes out of the enclosure 100 from the air outlets 431 under the drive of the power supply fan 50. Thus, the heat within the enclosure 100 is dissipated out of the enclosure 100.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An enclosure, comprising:
a chassis configured to receive a plurality of heating elements and define a plurality of air inlets; and
a power supply unit comprising a fixing bracket defining a plurality of air vents, a plurality of air outlets and a power supply fan fixed in the fixing bracket;
wherein the plurality of air inlets is configured to let air flow into the chassis to dissipate heat from the plurality of heating elements, into the power supply unit via the plurality of air vents, and out of the power supply unit via the plurality of air outlets.

2. The enclosure claim 1, wherein the chassis comprises a bottom plate, the power supply unit is located on the bottom plate.

3. The enclosure of claim 2, wherein a board is located on the bottom plate, a first heating element and a cooling fan are located on the board, and the cooling fan is configured to cool the first heating element.

4. The enclosure of claim 2, wherein the chassis comprises a front plate connected one end of the bottom plate, the front plate is substantially perpendicular to the bottom plate, and the air inlets are located on the front plate.

5. The enclosure of claim 4, wherein the chassis comprises a rear plate connected another end of the bottom plate, the rear plate is substantially perpendicular to the bottom plate, the rear plate defines an opening aligned with the air outlets.

6. The enclosure of claim 5, wherein the chassis comprises two parallel side plates, the bottom plate, the front plate, the rear plate, and two side plates are cooperatively define a receiving space, the power supply unit is received in the receiving space.

7. The enclosure of claim 1, wherein the fixing bracket comprises a first plate and a second plate, the air vents are located on the first plate and the second plate.

8. The enclosure of claim 7, wherein the fixing bracket comprises a third plate which is substantially parallel to the first plate, the air outlets are located on the third plate.

9. The enclosure of claim 8, wherein the power supply fan is fixed on the third plate and is aligned with the air outlets.

10. The enclosure of claim 8, wherein the third plate defines an interface, the interface is used to connect the external power supply.

11. A power supply unit, comprising:
a fixing bracket comprising a plurality of air vents and a plurality of air outlets; and
a power supply unit fixed on the fixing bracket;
wherein the power supply unit is fixed in a chassis of a enclosure, a plurality of heating elements is received in the chassis, the plurality of air inlets is configured to let air flow into the chassis to dissipate heat from the plurality of heating elements, and into the power supply unit via the plurality of air vents, and out of the power supply unit via the plurality of air outlets.

12. The power supply unit of claim 11, wherein the chassis comprises a bottom plate, the power supply unit is located on the bottom plate.

13. The power supply unit of claim 12, wherein a board is located on the bottom plate, a first heating element and a cooling fan are located on the board, and the cooling fan is configured to cool the first heating element.

14. The power supply unit of claim 12, wherein the chassis comprises a front plate connected one end of the bottom plate, the front plate is substantially perpendicular to the bottom plate, the air inlets are located on the front plate.

15. The power supply unit of claim 14, wherein the chassis comprises a rear plate connected another end of the bottom plate, the rear plate is substantially perpendicular to the bottom plate, the rear plate defines an opening aligned with the air outlets.

16. The power supply unit of claim 15, wherein the chassis comprises two parallel side plates, the bottom plate, the front plate, the rear plate, and two side plates are cooperatively define a receiving space, the power supply unit is received in the receiving space.

17. The power supply unit of claim 11, wherein the fixing bracket comprises a first plate and a second plate, the air vents are located on the first plate and the second plate.

18. The power supply unit of claim 17, wherein the fixing bracket comprises a third plate which is substantially parallel to the first plate, the air outlets are located on the third plate.

19. The power supply unit of claim 18, wherein the power supply fan is fixed on the third plate and is aligned with the air outlets.

20. The power supply unit of claim 18, wherein the third plate defines an interface, the interface is used to connect the external power supply.
